(19) United States
(12) Patent Application Publication
(10) Pub. No.: US 2026/0243590 A1
(43) Pub. Date: Aug. 20, 2026

(54) ULTRASONIC CONTAINER SCREENER

(71) Applicant: Battelle Memorial Institute, Columbus, OH (US)

(72) Inventors: Wesley C. Pirkle, New Albany, OH (US); Anthony Polinori, Powell, OH (US); Richard Shoaf, Westerville, OH (US); Tyler Karns, Columbus, OH (US); James E. Risser, Lutherville Timonium, MD (US)

(21) Appl. No.: 19/540,264

(22) Filed: Feb. 13, 2026

Related U.S. Application Data
(60) Provisional application No. 63/758,650, filed on Feb. 14, 2025.

(51) Int. Cl. G01F 1/667; G01F 23/2962; G01N 29/024

(52) U.S. Cl. CPC G01F 1/667; G01F 23/2962; G01N 29/024

(57) ABSTRACT

In certain aspects, a computer-implemented method includes receiving, at a processor from an at least one ultrasonic sensor, a start time at which an ultrasonic signal was transmitted from the at least one ultrasonic sensor and a received time at which a return ultrasonic signal was received at the at least one ultrasonic sensor. The method includes receiving, at the processor from a temperature sensor, a temperature of a wall of the container. The method includes receiving, at the processor from a dimension sensor, an imaging of the container. The method includes determining an overall pathlength for which the ultrasonic signal travels through the liquid. The method includes determining a temperature of the liquid. The method includes determining a speed of the ultrasonic signal through the liquid. The method includes determining, based on the speed of the ultrasonic signal through the liquid, whether liquid type is present in the container.

### CROSS-REFERENCE TO RELATED APPLICATION

The present application claims the benefit of priority under 35 U.S.C. § 119 from U.S. Provisional Patent Application Ser. No. 63/758,650 entitled “Ultrasonic Container Screener,” filed on Feb. 14, 2025, the disclosure of which is hereby incorporated by reference in its entirety for all purposes.

### TECHNICAL FIELD

The present disclosure generally relates to sensors, and more specifically relates to an ultrasonic container screener for detection of liquid type in a container.

### BACKGROUND

Liquids can be transported in containers of various sizes ranging from water bottles to fuel tanks to bulk shipping containers. Under certain scenarios, such as for security purposes, it is necessary to detect the type of liquid in the container. As such, there is a desire for an ultrasonic container screener that can detect a type of liquid in a non-invasive and time efficient manner.

The description provided in the background section should not be assumed to be prior art merely because it is mentioned in or associated with the background section. The background section may include information that describes one or more aspects of the subject technology.

### SUMMARY

According to certain aspects of the disclosed technology, an ultrasonic container screener is provided that enables non-intrusive identification of a presence of a liquid, liquid type, or liquid with dissolved substance(s) in a container for such actions as, but not limited to, drug interdiction, customs fraud monitoring, and threat detection.

According to certain aspects, an ultrasonic container screener for determining whether liquid type is present in a container is provided. An at least one ultrasonic sensor is in communication with a processor and an ultrasonic transducer. The at least one ultrasonic sensor is configured to be placed in contact with a surface of the container and transmit, via the ultrasonic transducer, an ultrasonic signal through the surface of the container and a liquid in the container. The at least one ultrasonic sensor is configured to receive, via the ultrasonic transducer, a return ultrasonic signal. The at least one ultrasonic sensor is configured to transmit, to the processor, a start time at which the ultrasonic signal was transmitted and a received time at which the return ultrasonic signal was received. A temperature sensor is in communication with the processor. The temperature sensor is configured to detect temperature of the wall of the container and to transmit the temperature of the wall detected to the processor. A dimension sensor is in communication with the processor. The dimension sensor is configured to capture an imaging of the container and to transmit, to the processor, the imaging of the container. The processor is configured to determine, based on the imaging of the container, an overall pathlength for which the ultrasonic signal travels through the liquid. The processor is configured to determine, based on the temperature of the wall detected and an emissivity of the material composition of the container, a temperature of the liquid. The processor is configured to determine, based on the start time, the received time, the temperature of the liquid, and the overall pathlength, a speed of the ultrasonic signal through the liquid. The process or is configured to determine, based on the speed of the ultrasonic signal through the liquid, whether liquid type is present in the container. In certain aspects, the processor is configured to return a fail determination when the speed of the ultrasonic signal through the liquid is not within the range of speeds of predetermined liquids stored in the database. In certain aspects, the processor is further configured to determine whether type of liquid is present in the container based on comparing the speed of the ultrasonic signal through the liquid to a specific speed of a known liquid. In certain aspects, the processor is configured to return a pass determination when the speed of the ultrasonic signal through the liquid matches the specific speed of the known liquid. In certain aspects, the processor is configured to return a fail determination when the speed of the ultrasonic signal through the liquid does not match the specific speed of the known liquid. In certain aspects, the processor is configured to determine the material composition of the container based on the imaging of the container received from the dimension sensor. In certain aspects, the processor is configured to receive input identifying the material composition of the container.

According to certain aspects, a computer-implemented method for determining whether liquid type is present in a container is provided. The method includes receiving, at a processor from an at least one ultrasonic sensor, a start time at which an ultrasonic signal was transmitted from the at least one ultrasonic sensor and a received time at which a return ultrasonic signal was received at the at least one ultrasonic sensor. The method includes receiving, at the processor from a temperature sensor, a temperature of a wall of the container. The method includes receiving, at the processor from a dimension sensor, an imaging of the container. The method includes determining, based on the imaging of the container, an overall pathlength for which the ultrasonic signal travels through the liquid. The method includes determining, based on the temperature of the wall detected and an emissivity of the material composition of the container, a temperature of the liquid. The method includes determining, based on the start time, the received time, the temperature of the liquid, and the overall pathlength, a speed of the ultrasonic signal through the liquid. The method includes determining, based on the speed of the ultrasonic signal through the liquid, whether liquid type is present in the container. In certain aspects, the method includes comparing the speed of the ultrasonic signal through the liquid to a range of speeds of predetermined liquids stored in a database. In certain aspects, the method includes returning a pass determination when the speed of the ultrasonic signal through the liquid is within the range of speeds of predetermined liquids stored in the database. In certain aspects, the method includes returning a fail determination when the speed of the ultrasonic signal through the liquid is not within the range of speeds of predetermined liquids stored in the database. In certain aspects, the method includes comparing the speed of the ultrasonic signal through the liquid to a specific speed of a known liquid. In certain aspects, the method includes returning a pass determination when the speed of the ultrasonic signal through the liquid matches the specific speed of the known liquid. In certain aspects, the method includes returning a fail determination when the speed of the ultrasonic signal through the liquid does not match the specific speed of the known liquid. In certain aspects, the method includes determining the material composition of the container based on the imaging of the container received from the dimension sensor. In certain aspects, the method includes receiving the material composition of the container via input from a user.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of a screening tool positioned for screening a tank containing liquid according to certain aspects of the disclosure.

FIG. 2 is a perspective front view of a processing subsystem of the screening tool of FIG. 1, according to certain aspects of the disclosure.

FIG. 3 is a perspective rear view of the processing subsystem of the screening tool of FIG. 1, according to certain aspects of the disclosure.

FIG. 4 is a side view of the processing subsystem of the screening tool of FIG. 1, according to certain aspects of the disclosure.

FIG. 5 is a front view of the processing subsystem of the screening tool of FIG. 1, according to certain aspects of the disclosure.

FIG. 6 is a top perspective view of the processing subsystem of the screening tool of FIG. 1 with a top removed, according to certain aspects of the disclosure.

FIG. 7 is a top view of the processing subsystem of the screening tool of FIG. 1 with the top removed, according to certain aspects of the disclosure.

FIG. 8 is a perspective view of a sensor arm subsystem of the screening tool of FIG. 1, according to certain aspects of the disclosure.

FIG. 9 is a front view of the sensor arm subsystem of the screening tool of FIG. 1, according to certain aspects of the disclosure.

FIG. 10 is a side view of the sensor arm subsystem of the screening tool of FIG. 1, according to certain aspects of the disclosure.

FIG. 11 schematically illustrates the interconnections of the screening tool of FIG. 1, according to certain aspects of the disclosure.

FIG. 12 is a front view of an interface of the sensor arm subsystem of the screening tool of FIG. 1, according to certain aspects of the disclosure.

FIG. 13 illustrates an example process for determining status states of the screening tool.

FIG. 14 is in environmental view illustrating an example ultrasonic container screener for detecting liquid type in a container, according to certain aspects of the disclosure.

FIG. 15 schematically illustrates a first example positioning of the ultrasonic container screener, according to certain aspects of the disclosure.

FIG. 16 schematically illustrates a second example positioning of the ultrasonic container screener, according to certain aspects of the disclosure.

FIG. 17 schematically illustrates a third example positioning of the ultrasonic container screener, according to certain aspects of the disclosure.

FIG. 18 schematically illustrates the interconnections of the ultrasonic container screener, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

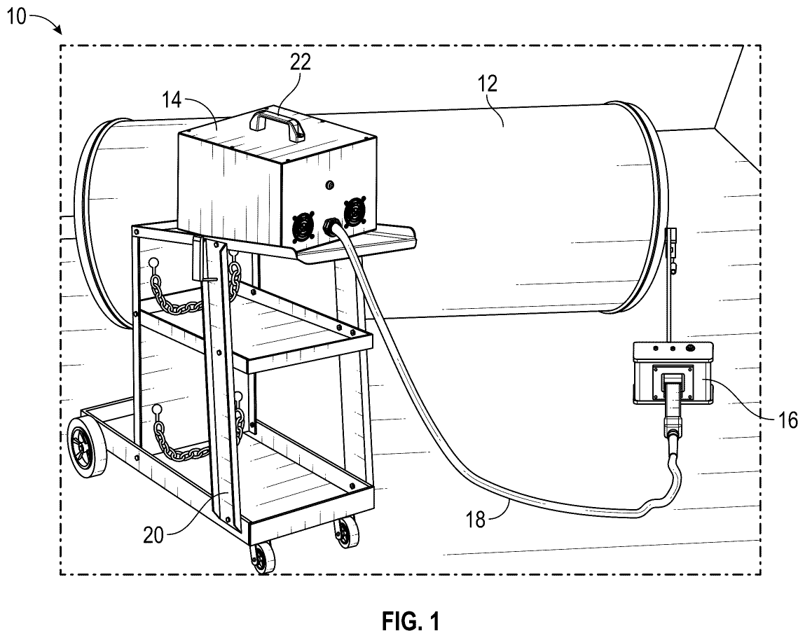

FIG. 1 depicts an environment in which a screening tool 10 can be useful. As is illustrated, the screening tool 10 is positioned for screening a container 12, which contains a liquid. It should be understood that the screening tool 10 is not necessarily illustrated to scale with respect to the container 12. The screening tool 10 includes a processing subsystem 14 and a sensor arm subsystem 16. The processing subsystem 14 is in communication with the sensor arm subsystem 16 via a cable 18. In the embodiment illustrated in FIG. 1, the cable 18 serves as a method of communication between the processing subsystem 14 and the sensor arm subsystem 16; however, in other embodiments, other communication methods or protocols can be incorporated into the screening tool 10. For example, the components of the screening tool 10 can be arranged to communicate through other methods or protocols, such as, for example, GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), Bluetooth protocols, Wi-Fi networks, RFID technology, and other appropriate communication methods and protocols. As will be described in more detail below, the screening tool 10 is configured to perform non-invasive inspections of containers, such as the container 12, to detect whether a predetermined type of liquid is contained in the container 12. In certain aspects, the container 12 is a fuel tank on a vehicle.

The screening tool 10 is portable and includes a handle 22 mounted on the processing subsystem 14 for carrying. In certain aspects, the screening tool 10 can be transported on a cart 20. While the cart 20 illustrated in FIG. 1 is a readily accessible utility cart 20, in certain embodiments the cart can be a customized cart built specifically to transport the screening tool 10 and/or the processing subsystem 14.

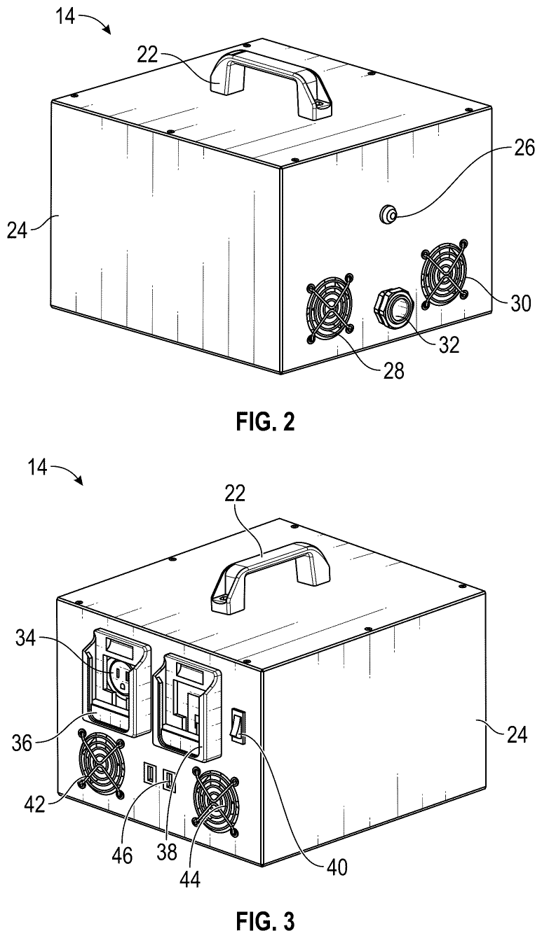

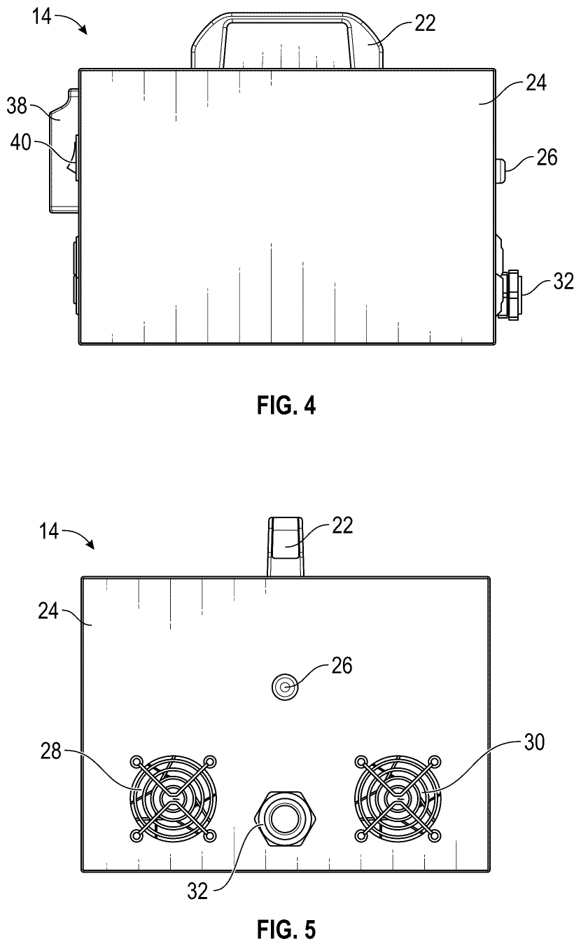

Referring to FIGS. 2-7, the processing subsystem 14 of the screening tool 10 includes a housing 24. The housing 24 can be substantially rectangular in shape, but other shapes are well within the scope of the present disclosure. The handle 22 is affixed to the top of the housing 24 and is configured to allow a user to carry the processing subsystem 14. Disposed on the front of the housing 24 of the processing subsystem 14 are a power button 26, a first front fan grill 28, a second front fan grill 30, and a first cable strain relief 32. The first cable strain relief 32 is configured to receive and support the cable 18. Disposed on the rear of the housing 24 of the processing subsystem 14 are a power receptacle 34, a first battery mount 36, a second battery mount 38, a power switch 40, a first rear fan grill 42, a second rear fan grill 44, and a pair of data ports 46. The processing subsystem 14 is illustrated with a pair of data ports 46; however, in other embodiments, the pair of data ports can be a single data port or three or more data ports depending on the intended implementation of the screening tool 10 and other factors. The power receptacle 34 can be, but is not limited to, an AC power receptacle. The screening tool 10 can be either powered with AC power by connecting a power cord (not illustrated) to the power receptacle 34 or by rechargeable batteries (not shown), which can be secured in the first battery mount 36 and/or the second battery mount 38 during use. When AC power is selected for use, the rechargeable battery would be unsecured from the first battery mount 36 to allow access to the power receptacle 34. In certain aspects, the power consumption of the screening tool 10 is approximately 50 watts (“W”). The data ports 46 can be any appropriate data port including, but not limited to, USB ports and other appropriate ports. The data ports 46 are configured for receiving various devices such as, but not limited to, a USB hub, a monitor, a mouse, a keyboard, a USB drive to enable data downloads, and other appropriate devices. In certain aspects, the approximate weight of the processing subsystem 14 is 15 lbs.

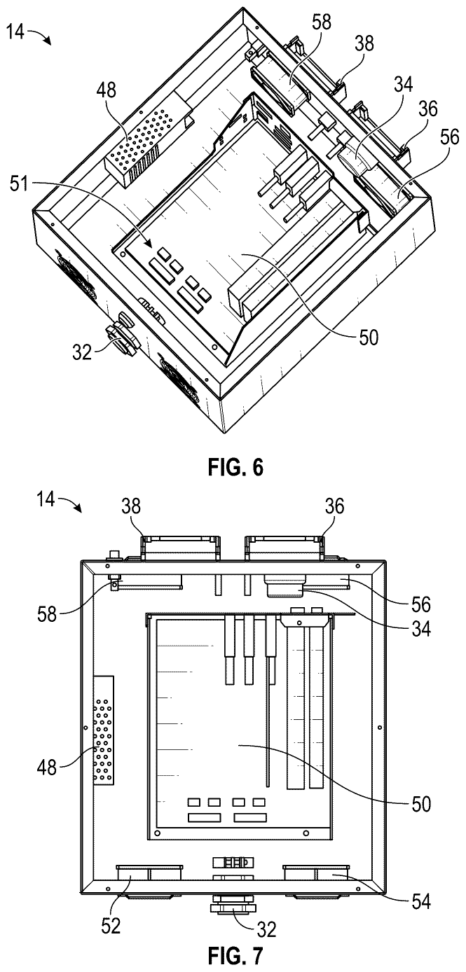

With particular reference to FIGS. 6-7 where the top of the housing 24 is removed to reveal components positioned inside the housing 24, an interior of the processing subsystem 14 includes a power converter 48 (e.g., AC/DC converter), a processor 50 in communication with, and electrically coupled to, ultrasonic components 51 (e.g., pulser/receiver, digital to analog converter (ADC), which are schematically illustrated in FIG. 11, a first front fan 52, a second front fan 54, a first rear fan 56, and a second rear fan 58. The first front fan 52 is positioned adjacent to the first front fan grill 28. The second front fan 54 is positioned adjacent to the second front fan grill 30. The first rear fan 56 is positioned adjacent to the first rear fan grill 42. The second rear fan 58 is positioned adjacent to the second rear fan grill 44. The first front fan 52, the second front fan 54, the first rear fan 56, and the second rear fan 58 are collectively configured to cool the interior of the processing subsystem 14 to facilitate effective operation of the processing subsystem 14. The processor 50 is configured to detect a previously selected liquid such as, but not limited to, diesel based on ultrasonic wavelength data received from the sensor arm subsystem 16 and characterized across environmental conditions for the previously selected liquid. The processor 50 is configured to control and communicate with the sensor arm subsystem 16, as described in more detail below. In certain aspects, the processor 50 is electrically coupled to the pair of data ports 46 for receiving and transmitting signals to various devices inserted into the pair of data ports 46. For example, in certain aspects, a data port of the pair of data ports 46 is a USB port configured to enable data downloads to an inserted USB drive.

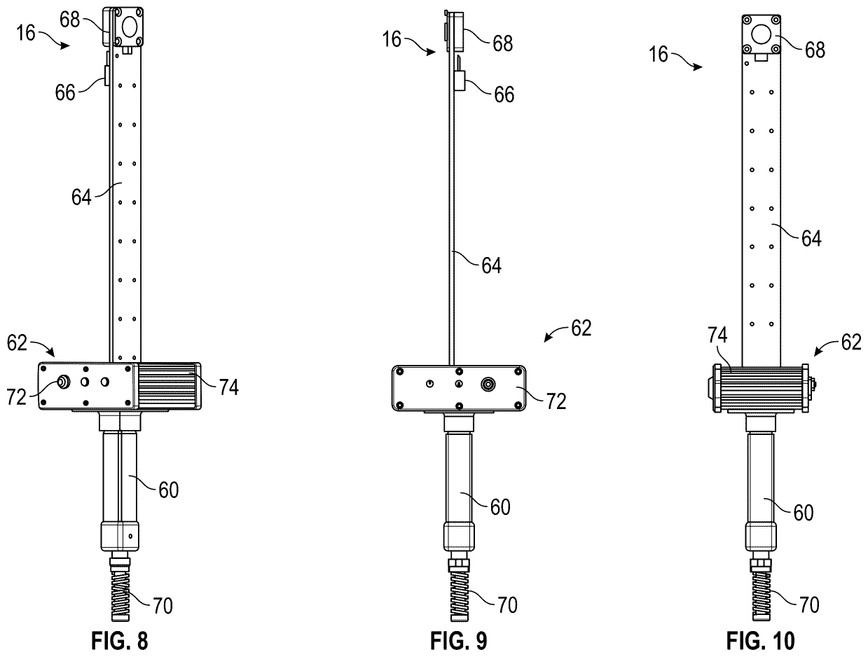

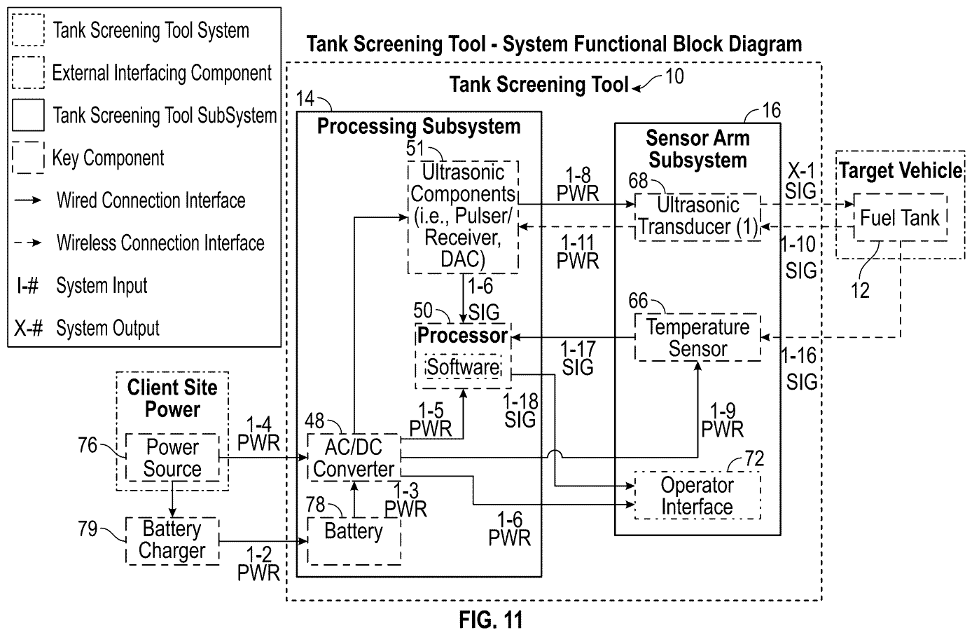

Moving to FIGS. 8-10, the sensor arm subsystem 16 includes a handgrip 60, a case 62, an arm 64, a temperature sensor 66, and a sensor 68. One side of the case 62 is coupled to the handgrip 60 while the arm 64 extends from the other opposite side of the case 62. The temperature sensor 66 can be, but is not limited to, a thermocouple, a thermistor, a resistance temperature detector, a semiconductor-based sensor, and other appropriate sensors capable of reading temperature. The temperature sensor 66 and the sensor 68 are attached to a distal end of the arm 64. A second cable strain relief 70 is coupled to the handgrip 60 and is configured to receive and support the cable 18. An operator interface 72 is coupled to the exterior of the case 62. In certain aspects, a speaker 74 is coupled to the case 62. The speaker 74 is configured to provide an audio alert when the processor 50 makes certain determinations such as, but not limited to, when presence of a substance other than the previously selected liquid is detected. In certain aspects, the sensor 68 is an ultrasonic sensor configured to send and receive ultrasonic pulses.

With reference to FIG. 11, in certain aspects, the cable 18 sheaths a plurality of wires for connecting components of the processing subsystem 14 to components of the sensor arm subsystem 16. For example, a first wire electrically couples the ultrasonic components 51 to the sensor 68, a second wire electrically couples the processor 50 to the temperature sensor 66, a third wire electrically couples the power converter 48 to the temperature sensor 66, a fourth wire electrically couples the power converter 48 to the operator interface 72, and a fifth wire electrically couples the processor 50 to the operator interface 72. In certain aspects, a sixth wire electrically couples the processor 50 to the speaker 74. As previously noted, while the embodiment illustrated and described includes wired communication, other embodiments of a screening tool can include various methods of wireless communication.

With further reference to FIG. 11, the power converter 48 is electrically coupled to, and in communication with, a number of other components to provide wired power such as the processor 50, the ultrasonic components 51, the temperature sensor 66, and the operator interface 72. The power converter 48 receives wired power from a power source 76 via the power receptacle 34 and from at least one battery 78, which can be rechargeable by the power source 76 via a charger 79. In certain aspects, the power converter 48 can either receive wired power from the power source 76 via the power receptacle 34 or from the at least one battery 78. The at least one battery 78 can be mounted to the first and second battery mount 36, 38. The processor 50 is directly or indirectly in communication with, and electrically coupled to, a number of components such as the ultrasonic components 51 to receive wired signals therefrom, the temperature sensor 66 to receive wired signals therefrom, the operator interface 72 to deliver wired signals thereto, and the power converter 48 to receive wired power therefrom. The ultrasonic components 51 are directly or indirectly in communication with, and electrically coupled to, a number of components such as the sensor 68 to receive wireless signals therefrom and to deliver wired power thereto, the processor 50 to deliver wire signals thereto, and the power converter 48 to receive wired power therefrom.

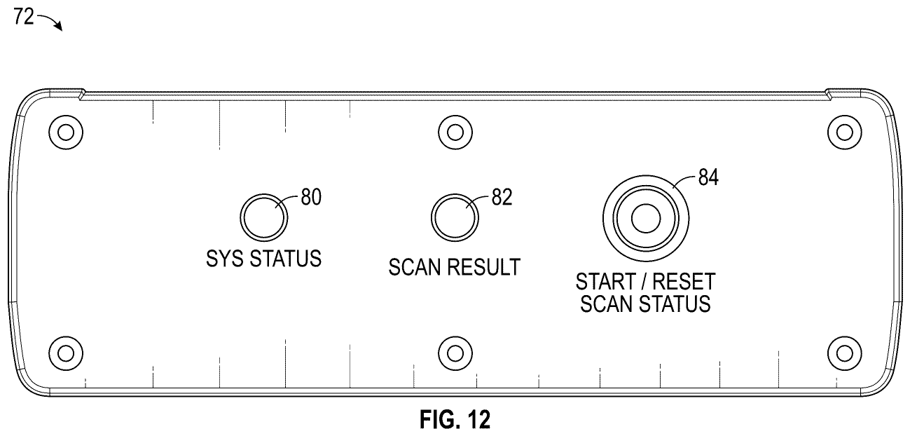

As depicted in FIG. 12, the operator interface 72 of the sensor arm subsystem 16 includes a first indicator 80, a second indicator 82, and a button indicator 84. The first indicator 80 is configured to indicate system status of the screening tool 10 with various lighting for different status. For example, the first indicator 80 can be unlit to indicate that the system status is “off,” can be lit with a first color (such as, but not limited to, green) to indicate that the system status is “system ready to scan,” and can be lit with a second color (such as, but not limited to, red) to indicate that the system status is “system not ready for scan.” The second indicator 82 is configured to indicate scan result status of the screening tool 10 with various lighting for different status. For example, the second indicator 82 can be unlit to indicate that the scan result status is “off,” can be lit with a first color (such as, but not limited to, green) to indicate that the scan made a positive detection of a previously selected liquid, and the scan result status can be lit with a second color (such as, but not limited to, red) to indicate that the scan detected a presence of a substance other than the previously selected liquid. The button indicator 84 is a combination button and indicator. The button of the button indicator 84 is configured to, responsive to engaging the button, start or reset the scan. The indicator of the button indicator 84 is configured to indicate scan status of the screening tool 10 with various lighting for different status. For example, the indicator of the button indicator 84 can be unlit to indicate that the scan status is “off,” can be lit with a first color (such as, but not limited to, green) to indicate a successful scan, can be lit with a flashing first color to indicate that the scan status is in progress, can be lit with a second color (such as, but not limited to, red) to indicate an unsuccessful scan, and can be lit with a flashing second color to indicate that the scan status is in a self-test. The button indicator 84 is strategically positioned on the operator interface 72 such that a user can maintain constant contact with the handgrip 60.

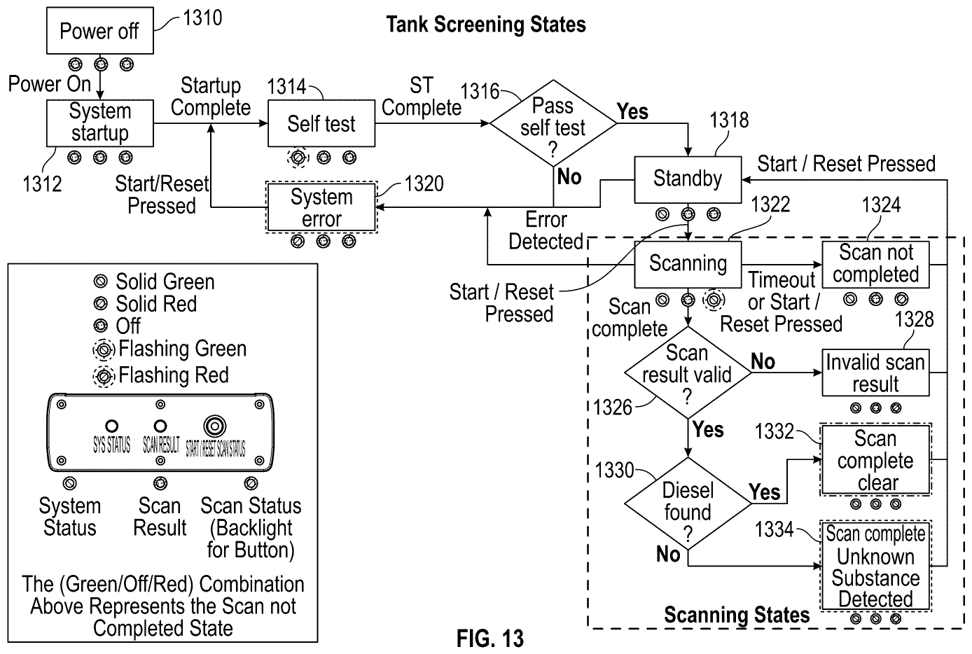

FIG. 13 illustrates a flow chart of an example process for determining status states of the first indicator 80, the second indicator 82, and the button indicator 84. As depicted at step 1310, the screening tool 10 is powered off and the first indicator 80, the second indicator 82, and the button indicator 84 are all unlit. When the screening tool 10 is powered on, as illustrated at step 1312, the processor 50 enters system startup and the first indicator 80, the second indicator 82, and the button indicator 84 all remain unlit. After the startup is completed, the processor 50 runs a self-test, as illustrated at step 1314, and the button indicator 84 is lit with the flashing second color to indicate that the scan status is in the self-test while the first indicator 80 and the second indicator 82 remain unlit. The processor 50 determines at step 1316 whether the self-test passes. When the processor 50 determines that the self-test passed the screening tool 10 proceeds to standby, as depicted at step 1318, and the first indicator 80 is lit with the first color to indicate that the system status is “system ready to scan” while the second indicator 82 and the button indicator 84 remain unlit. On the other hand, when the processor 50 determines that the self-test has not passed, as depicted at step 1320, the first indicator 80 is lit with the second color to indicate that the system status is “system not ready for scan” while the second indicator 82 and the button indicator 84 remain unlit. While not illustrated, the foregoing combinations can be documented either in a manual or on the sensing tool 10 to assist an operator who is operating the sensing tool 10.

As illustrated at step 1322, responsive to the button of the button indicator 84 being engaged, the processor 50 begins the scanning process such that the first indicator 80 is lit with the first color to indicate that the system status is “system ready to scan,” the button indicator 84 is lit with the flashing first color to indicate that the scan status is in progress, and the second indicator 82 is unlit. When the processor 50 determines that the scan has timed out or the button of the button indicator 84 has been engaged during the scanning process, as depicted at step 1324, the processor 50 stops the scanning process and changes the indicator of the button indicator 84 to be lit with the second color to indicate an unsuccessful scan while the first indicator 80 remains lit with the first color to indicate that the system status is “system ready for scan” and the second indicator 82 remains unlit. If the button of the button indicator 84 is engaged again after step 1324, then the process proceeds to step 1318.

After step 1322 when the scan is completed, the processor 50 determines whether the scan result is valid, as depicted at step 1326. When the processor 50 determines that the scan result is not valid, as depicted at step 1328, the first indicator 80 remains lit with the first color to indicate that the system status is “system ready for scan,” the second indicator 82 will remain unlit, and the button indicator 84 will be lit with the second color to indicate an unsuccessful scan. If the button of the button indicator 84 is engaged again after step 1328, then the process with proceed to step 1318. When the processor 50 instead determines that the scan result is valid at step 1326 the processor 50 then determines whether the previously selected liquid is detected, as depicted at step 1330. When the processor 50 determines that the previously selected liquid is detected, as illustrated at step 1332, the first indicator 80 remains lit with the first color to indicate that the system status is “system ready for scan,” the second indicator 82 will be lit with the first color to indicate that the scan made a positive detection of the previously selected liquid, and the button indicator 84 will be lit with the first color to indicate the successful scan. If the button of the button indicator 84 is engaged again after step 1332, then the process proceeds to step 1318.

When the processor 50 determines that the previously selected liquid is not detected at step 1330 the processor 50 completes the scan and indicates that an unknown substance is detected, as illustrated at step 1334, such that the first indicator 80 remains lit with the first color to indicate that the system status is “system ready for scan,” the second indicator 82 is lit with the first color to indicate that the scan detected a presence of a substance other than the previously selected liquid, and the button indicator 84 is lit with the second color to indicate that the scan was successfully completed.

In operation, the power button 26 and the power switch 40 are engaged to power on the screening tool 10. Once powered on, the processor 50 will conduct the self test. After the processor 50 determines that the self test passed, a user of the screening tool 10 can position the sensor 68 of sensor arm subsystem 16 proximate the container 12. Preferably, the sensor 68 is positioned at an end of the container 12 such that the sensor 68 sends ultrasonic pulses through the end and length of the container 12 and receives echoes of the pulses that bounce off the other end of the container 12. With the sensor 68 of the sensor arm subsystem 16 properly placed proximate the end of the container 12, the user can engage the button of the button indicator 84 to initiate the scan. During the scan, the sensor 68 sends ultrasonic pulses through the end and length of the container 12 and receives the echo of the pulses that bounce off the other end of the container 12. The sensor 68 then sends the received echo pulses to the ultrasonic components 51, which sends them to the processor 50 to determine whether the scan result is valid and whether the previously selected liquid is detected.

While not illustrated, the foregoing combinations can be documented either in a manual or on the sensing tool 10 to assist an operator who is operating the sensing tool 10.

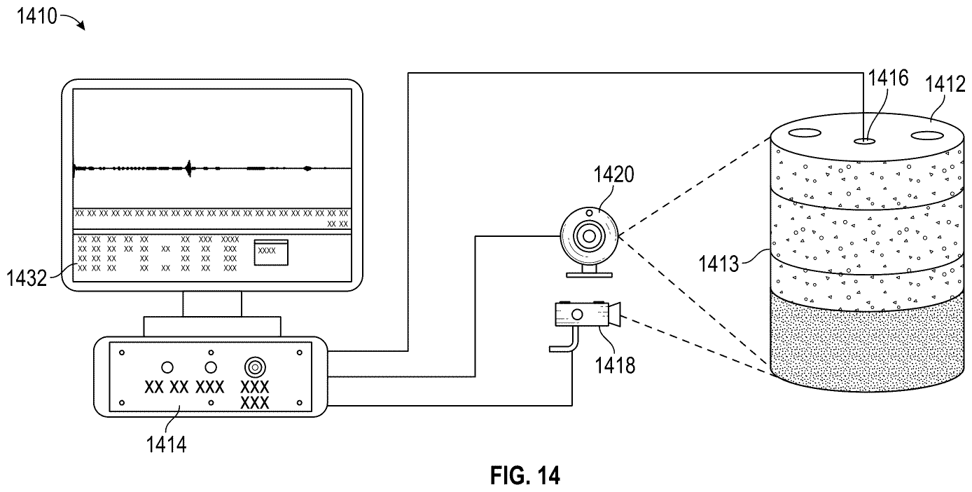

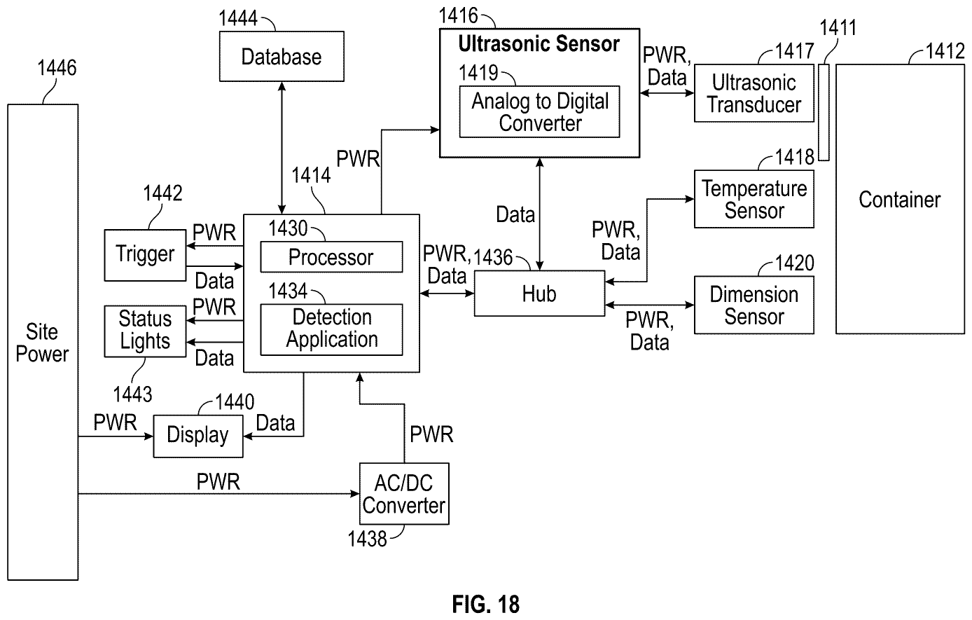

With reference to FIG. 14, an ultrasonic container screener 1410 for detecting liquid type in a container 1412 is illustrated in an environmental view. The container 1412 is defined by a wall 1413. Although the container 1412 is exemplarily illustrated as a metal drum, it should be understood that the container 1412 can be any appropriate container including, but not limited to, 16-gallon vehicle fuel tanks, 275-gallon HDPE IBC tanks, and 55-gallon metal drums. With continued reference to FIG. 14, and particular reference to FIG. 18, in certain aspects, the ultrasonic container screener 1410 includes a computing device 1414 that is in, wired or wireless, communication with at least one ultrasonic sensor 1416, a temperature sensor 1418, a dimension sensor 1420, and a display 1422. In certain aspects, the at least one ultrasonic sensor 1416 includes an analog-to-digital converter 1419. In certain aspects, the at least one ultrasonic sensor 1416 is in communication with an ultrasonic transducer 1417 that is configured to, in a pulse-echo mode, receive the pulse produced by the at least one ultrasonic sensor 1416, convert the pulse produced by the at least one ultrasonic sensor 1416 into an ultrasonic signal, transmit the ultrasonic signal, receive a return ultrasonic signal (e.g., the ultrasonic signal hits the opposite side of the container 1412 and reflects back), transmit the return ultrasonic signal to the at least one ultrasonic sensor 1416, which is configured to digitize the return ultrasonic signal and transmit the digitized return ultrasonic signal to a processor 1430 for analysis. In certain aspects, the at least one ultrasonic sensor 1416 includes an interface, which can be, but is not limited to, a USB-C interface, for interconnection with a port of the computing device 1414 or a hub 1436 in communication with the processor 1430 of the computing device 1414. In certain aspects, the computing device 1414 includes the processor 1430. In certain aspects, the processor 1430 is configured to run a GUI application 1432, conduct scans of the container 1412, and control and configure the at least one ultrasonic sensor 1416, the ultrasonic transducer 1417, the temperature sensor 1418, and the dimension sensor 1420.

While not illustrated, in other aspects, the at least one ultrasonic sensor 1416 includes a first ultrasonic sensor and second ultrasonic sensor that both operate in a transmission mode such that the first ultrasonic sensor is placed on one side or end of the container 1412 while the second ultrasonic sensor is placed on the opposite side or end of the container 1412.

The temperature sensor 1418 can be an appropriate sensor for measuring temperature of the wall 1413 of the container 1412 in order to determine the temperature of the contents (e.g., the liquid 1424) inside the container 1412 such as, but not limited to, an IR sensor, an IR thermometer, and other appropriate sensor for measuring temperature. In certain aspects, the temperature sensor 1418 is co-located with the at least one ultrasonic sensor 1416. The temperature sensor 1418 is configured to detect the temperature of the wall 1413 of the container 1412 for determining the temperature of the contents inside the container 1412 and transmit the temperature detected of the wall 1413 of the container 1412 to the processor 1430, which is configured to determine temperature of the contents inside the container (e.g., the liquid 1424) based on the temperature detected of the wall 1413 and the material compensation of the container 1412. In certain aspects, the temperature sensor 1418 has a ±1° C. accuracy tolerance. In certain aspects, the temperature sensor 1418 includes an interface, which can be, but is not limited to, a USB-C interface, for interconnection with a port of the computing device 1414 or the hub 1436 in communication with the processor 1430 of the computing device 1414.

The dimension sensor 1420 can be an appropriate sensor for capturing an imaging of the container 1412, which can be used for measuring dimensions of the container 1412 (e.g., pathlength), such as, but not limited to, an optical camera, a LiDAR sensor, an IR camera, and other appropriate sensors for capturing imagings. The dimension sensor 1420 is configured to transmit the imaging of the container 1412 that is captured to the processor 1430 for processing. The processor 1430 is configured to determine, based on the imaging of the container 1412, at least the ultrasonic pathlength of the container 1412, the type of the container 1412, and the material composition of the container 1412. The processor 1430, in turn, is configured to determine, based on the type of the container 1412, the material composition of the container 1412, and the temperature of the wall 1413, the temperature of the liquid 1424. In certain aspects, the dimension sensor 1420 is configured for robotics and spatial analytics applications. In certain aspects, the dimension sensor 1420 includes an interface, which can be, but is not limited to, a USB-C interface, for interconnection with a port of the computing device 1414 or the hub 1436 in communication with the processor 1430 of the computing device 1414.

As described in more detail below, the dimension sensor 1420 is configured to transmit the imaging of the container 1412 to the processor 1430, which is configured to, based on the imaging of the container 1412, measure the distance traveled by the ultrasonic signal in the liquid 1424. This can be determined by measuring the dimensions of the container 1412 and subtracting the thickness of the wall 1413 of the container 1412. The processor 1430 determines the edges of the container 1412 and makes a measurement from edge to edge of the container 1412 in the direction that the ultrasonic measurement is made. The processor 1430 is configured to use this information and determine the ultrasonic properties of the enclosed liquid (including speed of the ultrasonic signal through the liquid 1424. In certain aspects, the processor 1430 is configured to determine, based on the start time, the received time, the temperature of the wall 1413 detected, the pathlength, and a material composition of the container 1412, a speed of the ultrasonic signal through the liquid. In certain aspects, the processor 1430 is configured to determine, based on the speed of the ultrasonic signal through the liquid 1424, whether a type of liquid is present in the container.

In certain aspects, the processor 1430 is configured to determine whether type of liquid is present in the container 1412 based on comparing the speed of the ultrasonic signal through the liquid 1424 to a range of ultrasonic speeds of predetermined liquids stored in a database 1444 and the processor 1430 generates a pass/fail determination based on the comparison. When the processor 1430 determines that the speed of the ultrasonic signal through the liquid 1424 is within the range of ultrasonic speeds of predetermined liquids stored in the database 1444, the processor 1430 returns a pass determination, which may be displayed on the display 1422 and/or provided as an audio indication. In certain aspects, the pass determination can be, but is not limited to being, displayed on the display 1422 as a green clear identifier via the GUI application 1432. On the other hand, when the processor 1430 determines that the speed of the ultrasonic signal through the liquid is not within the range of ultrasonic speeds of predetermined liquids stored in the database, the processor 1430 returns a fail determination, which may be displayed on the display 1422 and/or provided as an audio indication. In certain aspects, the fail determination can be, but is not limited to being, displayed on the display 1422 as a red alarm identifier via the GUI application 1432.

In certain aspects, the processor 1430 is configured to determine whether type of liquid is present in the container 1412 based on comparing the speed of the ultrasonic signal through the liquid to a specific ultrasonic speed of a known liquid and the processor 1430 generates a pass/fail determination based on the comparison. When the processor 1430 determines that the ultrasonic speed of the ultrasonic signal through the liquid matches the specific ultrasonic speed of the known liquid, the processor 1430 returns a pass determination, which may be displayed on the display 1422 and/or provided as an audio indication. In certain aspects, the pass determination can be, but is not limited to being, displayed on the display 1422 as a green clear identifier via the GUI application 1432. On the other hand, when the processor 1430 determines that the ultrasonic speed of the ultrasonic signal through the liquid does not match the specific ultrasonic speed of the known liquid, the processor 1430 returns a fail determination, which may be displayed on the display 1422 and/or provided as an audio indication. In certain aspects, the fail determination can be, but is not limited to being, displayed on the display 1422 as a red alarm identifier via the GUI application 1432.

The dimension sensor is configured to capture the imaging of the container 1412 and transit that imaging of the container 1412 to the processor 1430 for determining the material composition of the container 1412 and the type of the container 1412. The processor 1430 is configured to determine the temperature of the liquid 1424 based on the composition of the container 1412, the type of the container 1412, and the temperature of the wall 1413 of the container 1412 received from the temperature sensor 1418. Metal, glass, and plastic containers all have different thicknesses as well as different emissivities. If the container thickness is not correctly determined, then the path length for the ultrasonic signal through the liquid will be incorrect and will lead to an inaccurate speed measurement. Emissivity is strongly impacted by the material of the container 1412 among other properties. An inaccurate emissivity will likely lead to an inaccurate temperature reading of the liquid. Liquid temperature strongly impacts the ultrasonic properties, and inaccurate data can lead to false positives and negatives.

In certain aspects, the processor 1430 is configured to display the imaging of the container 1412 received from the dimension sensor 1420 for identifying to a user an appropriate location on the container 1412 for placement of the ultrasonic transducer 1417 of the ultrasonic sensor 1416. This can be helpful to the user when the shape of the container 1412 is complex.

With further reference to FIG. 18, in certain aspects, the computing device 1414 can be powered from an on-site power source 1446 via a power cable that includes an AC/DC converter 1438. In other aspects, instead of being powered by the on-site power source, the computing device 1414 is powered by rechargeable batteries, which allows for portability of the computing device 1414, in some instances. A display 1440 is in communication with the processor 1430 of the computing device 1414. In certain aspects, the display 1440 is integrated into the computing device 1414. In other certain aspects, the display 1440 can be, but is not limited to, a remote display, a display of a tablet, smart glasses, smart goggles, and other appropriate displays. A trigger 1442 is in communication with the processor 1430 of the computing device 1414. When engaged the trigger 1142 is configured to initiate a scan, via the processor 1430, including activation of at least one of the at least one ultrasonic sensor 1416, the ultrasonic transducer 1417, the temperature sensor 1418, and the dimension sensor 1420. In certain aspects, the trigger 1442 is displayed on the display 1440 via the GUI application 1432. In other certain aspects, the trigger 1442 is a mechanical trigger in communication with the processor 1430. Status lights 1443 are in communication with the processor 1430 and are configured to indicate the status of the scan process. In certain aspects, the status lights 1443 and results of the scan can be displayed on the display 1440 via the GUI application 1432.

In certain aspects, the processor 1430 is configured to determine whether the liquid 1424 in the container 1412 is that which is expected or claimed to be in the container 1412. In other certain aspects, the processor 1430 is configured to identify type of liquid in the container 1412 by matching the speed determined to that of a known speed stored in the database 1444.

In certain aspects, the processor 1430 of the ultrasonic container screener 1410 is configured to detect a substance, such as, but not limited to, narcotics that are dissolved in a liquid 1424 in a container (e.g., the container 1412), and other liquid threats such as explosives and explosive precursors that may be in liquid form. In certain aspects, the ultrasonic container screener 1410 provides non-intrusive detection of the substance dissolved in the liquid 1424 in the container 1412 and, a time efficient analysis of the substance that is detected, to determine whether the detected substance is a threat. In certain aspects, the processor 1430 of the ultrasonic container screener 1410 identifies (e.g., flags) liquids that potentially have narcotics dissolved in it as well as identifies potentially dangerous liquids that do not have anything dissolved in them for further analysis.

In certain aspects, the at least one ultrasonic sensor 1416 extends from a handheld tool. The at least one ultrasonic sensor 1416 is configured to be placed in contact with a surface of the container 1412. With the at least one ultrasonic sensor 1416 placed on the surface of the container 1412, it is configured to transmit an ultrasonic signal and receive a return signal of the ultrasonic signal. The processor 1430 of the computing device 1414 is configured to receive ultrasonic measurements from the at least one ultrasonic sensor 1416 including, but not limited to, the start time at which the ultrasonic signal is transmitted, the received time at which the at least one ultrasonic sensor 1416 receives the return signal of the ultrasonic signal, attenuation of the waveform of the received ultrasonic signal for determining internal structure and material of the container 1412, reflections of the waveform of the received ultrasonic signal for determining internal structure and material of the container 1412, and other appropriate ultrasonic measurements. The processor 1430 of the computing device 1414 is configured to determine an ultrasonic travel time of the ultrasonic signal (e.g., time of flight (TOF)) by subtracting the start time from the received time. In certain aspects, the ultrasonic measurements are taken at a low frequency signal in the range of 40 kHz to 200 kHz. The ultrasonic signal must be efficiently coupled to the liquid 1424 in the container 1412, such that, in certain aspects, a coupling medium 1411 is disposed onto the at least one ultrasonic sensor 1416 before being placed on the surface of the container 1412. The coupling medium can be, but is not limited to, an ultrasonic gel, a solid polymer, or other appropriate couplant that mimics the ultrasonic properties of the at least one ultrasonic sensor 1416 and the container 1412 containing the liquid 1424. In certain aspects, the ultrasonic signal from the at least one ultrasonic sensor 1416 is coupled to the liquid 1424 through air with appropriate frequency settings.

The dimension sensor 1420 is configured to capture an imaging of the container 1412 and transmit the imaging of the container 1412 to the processor 1430 of the computing device 1414. The processor 1430 of the computing device 1414 is configured to receive the imaging of the container 1412 and determine an overall pathlength for which the ultrasonic signal will travel through the liquid 1424, which can be a dimension of the container 1412. In certain aspects, the processor 1430 of the computing device 1414 is configured to, based on receiving the imaging of the container 1412, identify the material of the container (such as, but not limited to metal, plastic, glass, and other materials), identify thickness of the container 1412, and other properties of the container. In certain aspects, the processor 1430 of the computing device 1414 is configured with, or in communication with, a machine learning module that is trained with dimensions and other properties (e.g., material type, thickness) of various containers. In other aspects, the processor 1430 is configured to receive the material type or material composition of the container 1412 as input from a user.

The temperature sensor 1418 is configured to detect a temperature of the liquid 1424 in the container 1412 and transmit the temperature of the liquid 1424 in the container to the processor 1430 of the computing device 1414. In certain aspects, the processor 1430 of the computing device 1414 is configured to determine adjusted temperature of the liquid 1424 based on the temperature received from the temperature sensor 1418 (e.g., measured temperature), material type of the container 1412, environment temperature, and other appropriate parameters. In certain aspects, temperature sensor 1418 is configured to adjust the measured temperature with emissivity of the container 1412 that is determined based on the material type of the container 1412, which may be determined via the dimension sensor 1420 and/or the processor 1430 of the computing device 1414.

The processor 1430 of the computing device 1414 is configured to determine the type of the liquid 1424 based on at least the ultrasonic travel time of the ultrasonic signal, the overall pathlength, and the temperature of the liquid 1424. For example, in certain aspects, the processor 1430 of the computing device 1414 is configured to determine a speed of sound with respect to the contents in the container 1412 based on the ultrasonic travel time of the ultrasonic signal and the overall pathlength as well as temperature compensation based on the temperature of the liquid 1424. With the speed of sound determined, the processor 1430 of the computing device 1414 is configured to determine the type of the liquid 1424 by comparing the speed of sound that is determined to a predetermined classification chart, which classifies type of liquid by speed of sound.

In certain aspects, for example, the ultrasonic travel time of the ultrasonic signal is the time the ultrasonic signal spends in the liquid 1424 (e.g., TOF). To measure an accurate TOF, it is important to obtain the total path length that the ultrasonic signal traveled, and how much of that total path length is within the liquid 1424 versus how much is within another liquid or air in the container 1412. With the TOF, the speed of the ultrasonic signal through the liquid 1424 can be calculated. The speed that the ultrasonic signal travels through the liquid 1424 is dependent on the temperature of the liquid 1424 such that temperature compensation is required for an accurate temperature of the liquid 1424. In certain aspects, the computing device 1414 is configured to compare the speed of the ultrasonic signal at the measured temperature (e.g., adjusted speed) against a list or range of speeds of predetermined liquids stored in the database 1444. If the speed values do not match for the liquid 1424 (e.g., presumed liquid) and the predetermined liquid, a notification (e.g., the processor 1430 returns the fail determination) is triggered. Responsive to the notification being triggered, additional measures can be taken to determine a reason why there was no match. In this manner, for example, narcotics dissolved in the liquid would alter the speed and trigger the notification.

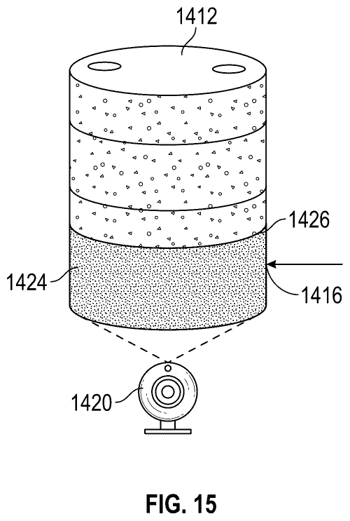

With reference to FIG. 15, in a first non-limiting example, the at least one ultrasonic sensor 1416 is placed in contact against the side of the container 1412 such that the overall path length is the width of the container 1412 (e.g., the liquid 1424 is entirely within the overall path length). The dimension sensor 1420 is placed below the container 1412 to capture the imaging of the container 1412, but could also be placed above the container 1412, such that the processor 1430 of the computing device 1414 can determine the overall path length from the captured imaging of the container 1412. The fluid level is not required for calculation, but an estimated fluid level is required for placement of the at least one ultrasonic sensor 1416 below a fill line 1426. The processor 1430 of the computing device 1414 is configured to determine the ultrasonic travel time of the ultrasonic signal over the overall path length (e.g., the width of the container 1412). For example, because the pulse-echo mode is implemented (e.g., the ultrasonic signal hits the opposite side of the container 1412 and reflects back to the at least one ultrasonic sensor 1416), the processor 1430 of the computing device 1414 is configured to determine the path length is, for example, the width of the container 1412). The processor 1430 of the computing device 1414 is configured to determine the type of the liquid 1424 based on the ultrasonic travel time, as well as the temperature of the liquid 1424.

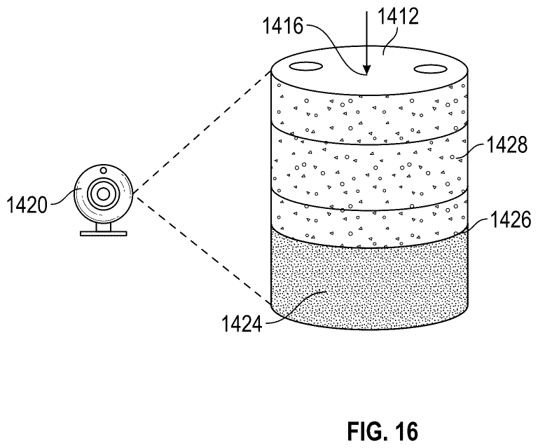

With reference to FIG. 16, in a second non-limiting example, the at least one ultrasonic sensor 1416 is placed in contact against the top surface of the container 1412 such that the overall path length is the height of the container 1412. The dimension sensor 1420 is placed to a side of the container 1412 to capture the imaging of the container 1412, such that the processor 1430 of the computing device 1414 can determine the overall path length from the captured imaging of the container 1412. In this example, the processor 1430 of the computing device 1414 is configured to determine the ultrasonic travel time, which measures the ultrasonic travel time of the ultrasonic signal over the overall path length (e.g., the height of the container 1412), as well as to determine a headspace ultrasonic travel time through the headspace 1428, which measures the time it takes for the ultrasonic signal to travel from the top of the container 1412 to the liquid/air interface (e.g., the fill line 1426) and back. For example, because the pulse-echo mode is implemented (e.g., the ultrasonic signal hits the opposite side of the container 1412 and reflects back to the at least one ultrasonic sensor 1416), the computing device 1414 is configured to determine the path length is, for example, the height of the container 1412). The processor 1430 of the computing device 1414 is configured to determine the type of the liquid 1424 based on the ultrasonic travel time, the headspace ultrasonic travel time, as well as the temperature of the liquid 1424.

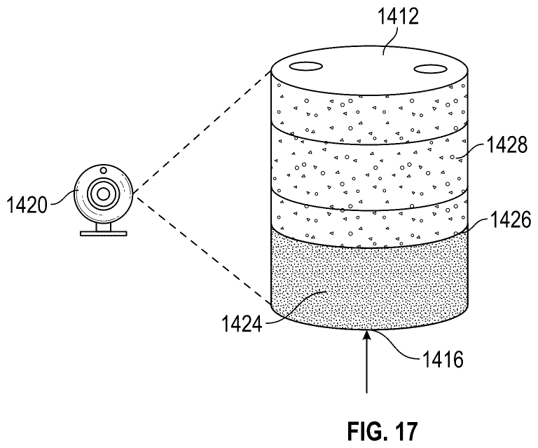

With reference to FIG. 17, in a third non-limiting example, the at least one ultrasonic sensor 1416 is placed in contact against the bottom surface of the container 1412 such that the overall path length is the height of the container 1412. The dimension sensor 1420 is placed to a side of the container 1412 to capture the imaging of the container 1412, such that the processor 1430 of the computing device 1414 can determine the overall path length from the captured imaging of the container 1412. In this example, the processor 1430 of the computing device 1414 is configured to determine the ultrasonic travel time, which measures the ultrasonic travel time of the ultrasonic signal over the overall path length (e.g., the height of the container 1412), as well as to determine a headspace ultrasonic travel time through the headspace 1428, by measuring the time it takes for the ultrasonic signal to travel from the bottom of the container 1412 to the liquid/air interface (e.g., the fill line 1426) and back. For example, because the pulse-echo mode is implemented (e.g., the ultrasonic signal hits the opposite side of the container 1412 and reflects back to the at least one ultrasonic sensor 1416), the processor 1430 of the computing device 1414 is configured to determine the path length is, for example, the height of the container 1412). The processor 1430 of the computing device 1414 is configured to determine the type of the liquid 1424 based on the ultrasonic travel time, the headspace ultrasonic travel time, as well as the temperature of the liquid 1424.

With respect to the headspace ultrasonic travel time, in certain aspects, reflections are determined in the received ultrasonic signal caused by all of the interfaces within the pathlength the signal traveled. As such, there will be a reflection, for example, at each interface such as, but not limited to, air/liquid interface, liquid A/liquid B interface, liquid/container interface, and other appropriate interfaces depending on the contents in the container 1412. At each interface some of the ultrasonic signal will be reflected back to the transducer while the rest will continue on into the next medium. There will then be a second reflection at the liquid/container interface. Using those two reflections, two measurements (e.g., total transit time and transit time through the first phase (either air or liquid) are determined, along with two unknowns (speed of sound in the liquid and location of the liquid/air interface) since the speed of sound in air is known. Based on these measurements, the location of the liquid/air interface and speed of sound in the liquid is determined. For example, a reflection at the air/liquid interface inside the container 1412 can be determined in this manner.

An exemplary process of operation of the ultrasonic container screener 1410 is described below. It should be noted that the exemplary process of operation of the ultrasonic container screener 1410 may be performed by other systems. In operation, for example, the ultrasonic container screener 1410 is positioned proximately to the container 1412 in interest. In particular, the dimension sensor 1420 is positioned to center the container 1412 in frame. The dimension sensor 1420 automatically detects the presence of the container 1412 and determines the material composition of the container 1412 and the path length, and transmits such information to the processor 1430 of the computing device 1414. The temperature sensor 1418 determines the temperature of the container 1412 in order to analyze the liquid 1424 in the container 1412, including the temperature of the liquid 1424. The processor 1430 then receives an expected liquid type, via user input, of the liquid 1424 in the container 1412. In certain aspects, the ultrasonic transducer 1417 is applied with the coupling medium 1411 and then placed in contact with a surface of the container 1412 below the fill level of the liquid 1424. Responsive to the trigger 1442 being engaged, the processor 1430 initiates scanning via the at least one ultrasonic sensor 1416 and the ultrasonic transducer 1417. After the scanning is complete, the processor 1430 determines the measured properties of the liquid 1424 and compares to the selected properties of liquids stored in the database 1444. If the measured properties of the liquid 1424 in the container matches the selected properties stored in the database 1444, the processor 1430 returns a pass determination, which may be displayed on the display 1422 as a green clear identifier via the GUI application 1432. On the other hand, if the measured properties of the liquid 1424 in the container does not match any of the selected properties stored in the database 1444, the processor 1430 returns a fail determination, which may be displayed on the display 1422 as a red alarm identifier via the GUI application 1432 and/or as an audio alarm signal.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An ultrasonic container screener for determining whether liquid type is present in a container, comprising:
an at least one ultrasonic sensor in communication with a processor and an ultrasonic transducer, wherein the at least one ultrasonic sensor is configured to be placed in contact with a surface of the container and transmit, via the ultrasonic transducer, an ultrasonic signal through the surface of the container and a liquid in the container, and wherein the at least one ultrasonic sensor is configured to receive, via the ultrasonic transducer, a return ultrasonic signal, wherein the at least one ultrasonic sensor is configured to transmit, to the processor, a start time at which the ultrasonic signal was transmitted and a received time at which the return ultrasonic signal was received;
a temperature sensor in communication with the processor, wherein the temperature sensor is configured to detect temperature of the wall of the container and to transmit the temperature of the wall detected to the processor; and
a dimension sensor in communication with the processor, wherein the dimension sensor is configured to capture an imaging of the container and to transmit, to the processor, the imaging of the container,
wherein the processor is configured to
determine, based on the imaging of the container, an overall pathlength for which the ultrasonic signal travels through the liquid;
determine, based on the temperature of the wall detected and an emissivity of the material composition of the container, a temperature of the liquid;
determine, based on the start time, the received time, the temperature of the liquid, and the overall pathlength, a speed of the ultrasonic signal through the liquid; and
determine, based on the speed of the ultrasonic signal through the liquid, whether liquid type is present in the container.

2. The ultrasonic container screener of claim 1, wherein the processor is further configured to determine whether liquid type is present in the container based on comparing the speed of the ultrasonic signal through the liquid to a range of speeds of predetermined liquids stored in a database.

3. The ultrasonic container screener of claim 2, wherein the processor is configured to return a pass determination when the speed of the ultrasonic signal through the liquid is within the range of speeds of predetermined liquids stored in the database.

4. The ultrasonic container screener of claim 2, wherein the processor is configured to return a fail determination when the speed of the ultrasonic signal through the liquid is not within the range of speeds of predetermined liquids stored in the database.

5. The ultrasonic container screener of claim 1, wherein the processor is further configured to determine whether type of liquid is present in the container based on comparing the speed of the ultrasonic signal through the liquid to a specific speed of a known liquid.

6. The ultrasonic container screener of claim 5, wherein the processor is configured to return a pass determination when the speed of the ultrasonic signal through the liquid matches the specific speed of the known liquid.

7. The ultrasonic container screener of claim 5, wherein the processor is configured to return a fail determination when the speed of the ultrasonic signal through the liquid does not match the specific speed of the known liquid.

8. The ultrasonic container screener of claim 1, wherein the processor is configured to determine the material composition of the container based on the imaging of the container received from the dimension sensor.

9. The ultrasonic container screener of claim 1, wherein the processor is configured to receive the material composition of the container via input from a user.

10. The ultrasonic container screener of claim 1, wherein the temperature sensor is an infrared sensor and the dimension sensor is an optical camera.

11. A computer-implemented method for determining whether liquid type is present in a container, the method comprising:
receiving, at a processor from an at least one ultrasonic sensor, a start time at which an ultrasonic signal was transmitted from the at least one ultrasonic sensor and a received time at which a return ultrasonic signal was received at the at least one ultrasonic sensor;
receiving, at the processor from a temperature sensor, a temperature of a wall of the container;
receiving, at the processor from a dimension sensor, an imaging of the container;
determining, based on the imaging of the container, an overall pathlength for which the ultrasonic signal travels through the liquid;
determining, based on the temperature of the wall detected and an emissivity of the material composition of the container, a temperature of the liquid;
determining, based on the start time, the received time, the temperature of the liquid, and the overall pathlength, a speed of the ultrasonic signal through the liquid; and
determining, based on the speed of the ultrasonic signal through the liquid, whether liquid type is present in the container.

12. The computer-implemented method of claim 11, wherein determining whether liquid type is present in the container further comprises
comparing the speed of the ultrasonic signal through the liquid to a range of speeds of predetermined liquids stored in a database.

13. The computer-implemented method of claim 12, further comprising
returning a pass determination when the speed of the ultrasonic signal through the liquid is within the range of speeds of predetermined liquids stored in the database.

14. The computer-implemented method of claim 12, further comprising
returning a fail determination when the speed of the ultrasonic signal through the liquid is not within the range of speeds of predetermined liquids stored in the database.

15. The computer-implemented method of claim 11, wherein determining whether type of liquid is present in the container further comprises
comparing the speed of the ultrasonic signal through the liquid to a specific speed of a known liquid.

16. The computer-implemented method of claim 15, further comprising
returning a pass determination when the speed of the ultrasonic signal through the liquid matches the specific speed of the known liquid.

17. The computer-implemented method of claim 15, further comprising
returning a fail determination when the speed of the ultrasonic signal through the liquid does not match the specific speed of the known liquid.

18. The computer-implemented method of claim 11, further comprising
determining the material composition of the container based on the imaging of the container received from the dimension sensor.

19. The computer-implemented method of claim 11, further comprising
receiving the material composition of the container via input from a user.

20. The computer-implemented method of claim 11, wherein the temperature sensor is an infrared sensor and the dimension sensor is an optical camera.
